(19) United States
(12) Patent Application Publication
(10) Pub. No.: US 2014/0165453 A1
(43) Pub. Date: Jun. 19, 2014

(54) Rodent Fork and Method of Use

(71) Applicants: Joshua Lee Baker, Memphis, TN (US); Philip Lee Molteni, Nashville, TN (US)

(72) Inventors: Joshua Lee Baker, Memphis, TN (US); Philip Lee Molteni, Nashville, TN (US)

(21) Appl. No.: 13/719,139

(22) Filed: Dec. 18, 2012

(51) Int. Cl. A01M 17/00

(52) U.S. Cl. CPC A01M 17/00
USPC 43/124

(57) ABSTRACT

A rodent fork and method of use for eradicating burrowing rodents that are beneath the surface of the ground. The fork includes a shaft having a proximal end with a grip and also having a distal end, a base plate attached transverse to the shaft at the distal end, and a first plurality of parallel tines fixedly attached the base plate and extending outwardly therefrom and substantially parallel to the shaft, with the tines being spaced apart on the plate in a second plurality of rows. An extraction plate is also preferably provided having a first plurality of holes spaced for receipt of the extraction plate onto the parallel tines, with the extraction plate having a flange, and preferably two flanges, extending laterally therefrom so that a user's foot may urge the extraction plate along the tines in a direction away from the base plate.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to yard tools, and, in particular, to implements and methods of use thereof for ridding a yard or garden of burrowing rodents.

2. Information Disclosure Statement

It is often desired to eradicate burrowing rodents such as moles and other vermin from a yard or garden. Well-known solutions for this problem include poisons, but poisons can be harmful to pets and children. While the location of burrowing rodents can be approximated by seeing the uprooted lawn surface as the rodent burrows beneath the surface, the rodents are quick and their exact position cannot be known for certain.

It is therefore desirable to have a tool and method of use of such a tool for eradicating burrowing rodents without using poisons.

Gardening implements, such as pitchforks that have a plurality of tines, are known for cultivating gardens, but the limited number of tines and their orientation in a single line limit their suitability for impaling burrowing rodents. Examples of such well-known pitchforks are Cox, U.S. Pat. No. 250,039 (issued Nov. 22, 1881), and Bell, U.S. Pat. No. 1,216,926 (issued Feb. 20, 1917).

A model 7880 three-claw gardening tool is sold by Fiskars Brands, Inc., 2537 Daniels St., Madison, Wis. 53718, for removing weeds, but it has different structure from the present invention and is instead suitable for removing weeds from a garden, and it is not suitable for removing burrowing rodents from a yard.

A cultivating tool is sold under the trademark GARDEN CLAW® by Garden Weasel Division of Faultless Starch/Bon Ami Company, 1025 W. 8th St., Kansas City, Mo. 64101-1200, and has four curved claws that extend downwardly for turning the soil. The structure of this cultivating tool is different from that of the present invention, and the curved claws are not suitable for removing burrowing rodents from a yard.

None of these references, either singly or in combination, discloses or suggests the present invention.

### BRIEF SUMMARY OF THE INVENTION

The present invention is a rodent fork and method of use for eradicating burrowing rodents that are beneath the surface of the ground. The fork includes a shaft having a proximal end with a grip and also having a distal end, a base plate attached transverse to the shaft at the distal end, and a first plurality of parallel tines fixedly attached the base plate and extending outwardly therefrom and substantially parallel to the shaft, with the tines being spaced apart on the plate in a second plurality of rows. An extraction plate is also preferably provided having a first plurality of holes spaced for receipt of the extraction plate onto the parallel tines, with the extraction plate having a flange, and preferably two flanges, extending laterally therefrom so that a user's foot may urge the extraction plate along the tines in a direction away from the base plate.

It is an object of the present invention to provide a rodent fork and method of use for eradicating burrowing rodents without the use of poisons.

### BRIEF DESCRIPTION OF THE SEVERAL VIEWS OF THE DRAWING

FIG. 1 is a side view of the present invention being used to impale a burrowing rodent.

FIG. 2 is a perspective view of the present invention.

FIG. 3 is an upward-looking view showing the parallel tines on the base plate, with the extraction plate having been removed from the tines.

FIG. 4 is a downward-looking plan view of the extraction plate, removed from the tines.

FIG. 5 is a front view of the distal end of the shaft, showing the parallel tines attached to the base plate and showing movement of the extraction plate along the tines.

FIG. 6 is a side view of the distal end of the shaft, showing the parallel tines attached to the base plate and showing movement of the extraction plate along the tines.

### DETAILED DESCRIPTION OF THE INVENTION

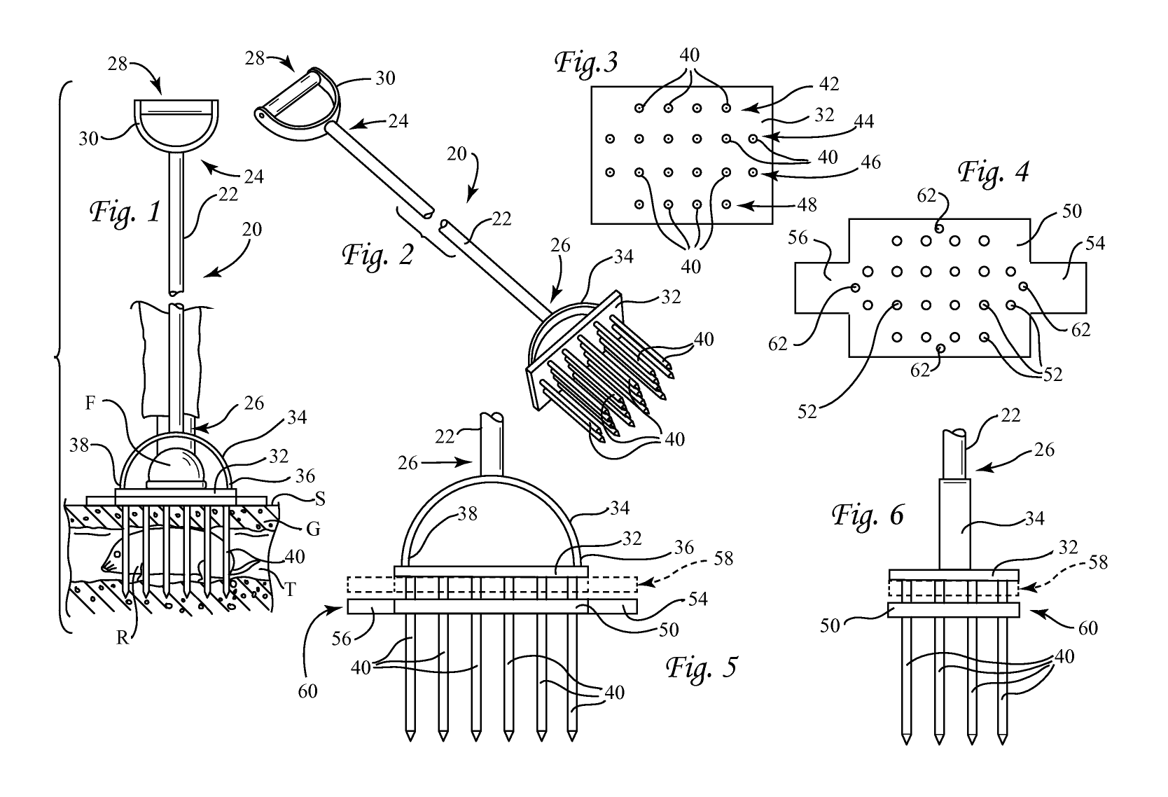

Referring to FIGS. 1-6, rodent fork 20 is seen to comprise an elongated and preferably metal shaft 22 having a proximal end 24 and a distal end 26. Shaft 22 includes a well-known handle or grip 28 at proximal end 24 so that a user can firmly grip the rodent fork 20 with a hand when raising and lowering the rodent fork 20 during the impaling of an underground rodent R that is traveling through a tunnel T under the surface S of the ground G. Grip 28 is preferably joined to shaft 22 by a generally U-shaped metal grip bracket 30 that is preferably weldedly joined to shaft 22.

Rodent fork 20 further includes a base plate 32 that is attached transverse to shaft 22 at distal end 26, preferably as by an arched base bracket 34 formed from a curved band of about 0.16 inches (4.0 mm) thick metal having left and right ends 36, 38 that are weldedly joined to base plate 32, and with shaft 22 preferably being weldedly joined to the midpoint of base bracket 34. Base plate 32 is preferably of a sturdy metal about 6.81 inches (17.3 cm) long and 4.5 inches (11.4 cm) wide and 0.16 inch (4.0 mm) thick. Base bracket 34 preferably has an arch height of about 4.5 inches (11.4 cm) above base plate 32 for allowing a user's shoe-protected foot F to fit therewithin and rest on the top of base plate 32 as shown in FIG. 1.

Preferably the length of shaft 22 is about 30 inches (76.2 cm) from the top of grip 28 to the top of base bracket 34, with grip 28 preferably being about 5.0 inches (12.7 cm) wide and being about 4.0 inches (10.2 cm) from the top of grip 28 to the junction of shaft 22 with the bottom of grip bracket 30.

Rodent fork 20 further comprises a first plurality of parallel sharply-pointed tines 40, preferably 20 in number, fixedly attached perpendicular to base plate 32 as by welding and extending longitudinally outwardly (downwardly) from base plate 32 and substantially parallel to shaft 22. Each of tines 40 is preferably about 5.63 inches (14.3 cm) long and about 0.19 inch (4.8 mm) in diameter. Tines 40 are spaced apart from one another on base plate 32 in a second plurality of rows, preferably four rows 42, 44, 46, 48 as shown, such as by having a first row 42 with four of tines 40 thereon, a second row 44 with six of tines 40 thereon, a third row 46 with six of tines 40 thereon, and a fourth row 48 with four of tines 40 thereon, for a total of 20 tines preferably organized into a regular grid pattern as shown. With tines 40 being spaced apart from one another on base plate 32 in a plurality of rows, a large impaling area is covered so as to increase the probability of impaling the rodent R even if the rodent's exact position is not known, or even if the rodent R moves slightly during the impaling process.

Rodent fork 20 preferably also comprises an extraction plate 50 about 6.81 inches (17.3 cm) long and 4.5 inches (11.4 cm) wide and 0.16 inch (4.0 mm) thick, corresponding to the dimensions of base plate 32, and extraction plate 50 has a like plurality of holes 52 therethrough as the number of tines 40, with holes 52 being in spaced alignment with the arrangement of tines 40, each tine 40 having a corresponding hole 52 in alignment therewith, and with each hole 52 having an inner diameter slightly larger than the outer diameter of its corresponding tine 40, such that extraction plate 50 is loosely received upon tines 40 for movement therealong, with each tine 40 being through its corresponding hole 52, for movement of extraction plate 50 along tines 40 from a first position 58 (shown in dotted outline in FIGS. 5 and 6) against base plate 32 to a second position 60 (shown in solid outline in FIGS. 5 and 6) away from base plate 32. Preferably, extraction plate 50 may be provided with a plurality of recessed magnets 62 for holding extraction plate 50 against base plate 32 in first position 58.

Extraction plate 50 preferably includes a laterally-extending flange, such as left and right flanges 54, 56 extending laterally outward about 2.5 inches (6.35 cm) from extraction plate 50. It has been experimentally found that, after impaling an underground rodent R with the tines 40 of rodent fork 20, a piece of sod often is pulled from the ground with the impaled rodent as the rodent fork is subsequently raised. Extraction plate 50 allows the user to replace the sod and, if desired, bury the now-dead rodent, by placing the user's left and right feet respectively on the left and right flanges 54, 56 of extraction plate 50 and then raising the rodent fork 20 while keeping the extraction plate 50 held to the ground, thereby efficiently extracting the dead rodent and sod from tines 40. It will be understood that magnets 62 keep extraction plate 50 held against base plate 32 until this extraction step is performed.

In order to use the rodent fork of the present invention and practice the method of use of the rodent fork, the user locates an underground rodent, as by observing the rodent's burrowing behavior, grasps grip 28 and places a foot within the arch of base bracket 34 and upon the top of base plate 32. The user then forcibly and simultaneously applies downward pressure upon the grip and base plate using hand and foot exertion, thereby inserting and driving tines 40 rapidly downwardly into the ground and impaling the rodent R on the tines. The user then steps on left and right flanges 54, 56 with left and right feet, respectively, and then lifts the rodent fork, thereby moving the extraction plate 50 in a direction away from base plate 32 so as to remove the impaled rodent and sod from tines 40.

### INDUSTRIAL APPLICABILITY

The rodent fork and method of use of the present invention are used for eradicating burrowing rodents that are beneath the surface of the ground. As compared to prior art methods and compounds for eradicating burrowing rodents, the present invention does not involve the use of poisons that might harm children and/or pets.

Although the present invention has been described and illustrated with respect to a preferred embodiment and a preferred use therefor, it is not to be so limited since modifications and changes can be made therein which are within the full intended scope of the invention.

We claim:

1. A rodent fork comprising:
(a) a shaft having a proximal end and a distal end, said shaft having a grip at said proximal end;
(b) a base plate attached transverse to said shaft at said distal end; and
(c) a first plurality of parallel tines fixedly attached to said base plate and extending longitudinally outwardly therefrom and substantially parallel to said shaft, said tines being spaced apart on said base plate in a second plurality of rows.

2. A method of eradicating burrowing underground rodents using the rodent fork of claim 1, said method comprising the steps of:
(a) providing the rodent fork as recited in claim 1;
(b) providing an underground rodent to be eradicated;
(c) inserting said first plurality of said parallel tines into the ground and impaling the rodent thereon.

3. The rodent fork as recited in claim 1, in which said parallel tines are spaced apart on said base plate in a first row having four of said tines, a second row having six of said tines, a third row having six of said tines, and a fourth row having four of said tines.

4. A method of eradicating burrowing underground rodents using the rodent fork of claim 3, said method comprising the steps of:
(a) providing the rodent fork as recited in claim 3;
(b) providing an underground rodent to be eradicated;
(c) inserting said first plurality of said parallel tines into the ground and impaling the rodent thereon.

5. The rodent fork as recited in claim 3, in which said fork further comprises an extraction plate having a like first plurality of holes therethrough in spaced alignment with said parallel tines, said extraction plate being loosely received upon said tines for movement therealong.

6. The rodent fork as recited in claim 5, in which said extraction plate includes a flange extending laterally therefrom.

7. A method of eradicating burrowing underground rodents using the rodent fork of claim 6, said method comprising the steps of:
(a) providing the rodent fork as recited in claim 6;
(b) providing an underground rodent to be eradicated;
(c) inserting said first plurality of said parallel tines into the ground and impaling the rodent thereon; then
(d) moving said extraction plate along said tines in a direction away from said base plate.

8. A method of eradicating burrowing underground rodents using the rodent fork of claim 5, said method comprising the steps of:
(a) providing the rodent fork as recited in claim 5;
(b) providing an underground rodent to be eradicated;
(c) inserting said first plurality of said parallel tines into the ground and impaling the rodent thereon; then
(d) moving said extraction plate along said tines in a direction away from said base

9. The rodent fork as recited in claim 1, in which said fork further comprises an extraction plate having a like first plurality of holes therethrough in spaced alignment with said parallel tines, said extraction plate being loosely received upon said tines for movement therealong.

10. The rodent fork as recited in claim 9, in which said extraction plate includes a flange extending laterally therefrom.

11. A method of eradicating burrowing underground rodents using the rodent fork of claim 10, said method comprising the steps of:
(a) providing the rodent fork as recited in claim 10;
(b) providing an underground rodent to be eradicated;
(c) inserting said first plurality of said parallel tines into the ground and impaling the rodent thereon; then
(d) moving said extraction plate along said tines in a direction away from said base plate.

12. A method of eradicating burrowing underground rodents using the rodent fork of claim 9, said method comprising the steps of:
(a) providing the rodent fork as recited in claim 9;
(b) providing an underground rodent to be eradicated;
(c) inserting said first plurality of said parallel tines into the ground and impaling the rodent thereon; then
(d) moving said extraction plate along said tines in a direction away from said base plate.
